(19) United States
(12) Patent Application Publication
(10) Pub. No.: US 2013/0250048 A1
(43) Pub. Date: Sep. 26, 2013

(54) METHOD OF CAPTURE, DISPLAY AND SHARING OF ORIENTATION-BASED IMAGE SETS

(71) Applicant: Joshua Victor Aller, Portland, OR (US)

(72) Inventor: Joshua Victor Aller, Portland, OR (US)

(21) Appl. No.: 13/739,191

(22) Filed: Jan. 11, 2013

Related U.S. Application Data
(60) Provisional application No. 61/586,496, filed on Jan. 13, 2012.
(60) Provisional application No. 61/599,360, filed on Feb. 15, 2012.

(51) Int. Cl. H04N 5/232

(52) U.S. Cl. CPC H04N 5/23238
USPC 348/37; 386/224

(57) ABSTRACT

Captured images are associated with orientation. An imaginary rotational control can be used to play back the captured images associated with orientation.

### RELATED APPLICATION DATA

This application claims priority benefit to copending provisional applications 61/586,496, filed Jan. 13, 2012, and 61/599,360, filed on Feb. 15, 2012, both of which are entitled “Method of Capture and Display and Sharing of Orientation-Based Image Sets.”

The subject matter of the present application also relates to that of expired provisional application 61/491,326, “Method of Orientation Determination by Sensor Fusion,” filed on May 30, 2011, which forms part of this specification as an Appendix.

### INTRODUCTION

The reader is presumed to be familiar with reference works including “Beginning iOS 5 Development: Exploring the iOS SDK,” by David Mark, Jack Nutting, and Jeff LaMarche, published by Apress on Dec. 7, 2011. ISBN-13: 978-1430236054; and “iPhone Developers Guide,” https://developer.apple.com/library/iosNdocumentation/Xcode/Conceptual/ios_development_workflow/00-About_the_iOS_Application_Development_Workflow/introduction.html

In one aspect, the present technology concerns a form of media, hereafter in this document called a “Spin” as well as a means of collection, display, dissemination, and social sharing of items of this media type.

A mobile app, SpinCam, is described that utilizes the principles described in this disclosure.

This app in principle can run on any device with a camera, such as a PDA, iPad, and iPod Touch, in addition to smartphones such as the iPhone and Android devices.

This document assumes the reader is skilled in the arts of software development, video capture and playback, smartphone sensors (such as gyroscope, magnetic compass), panoramic imagery viewing, and social media sharing.

### BRIEF DESCRIPTION OF THE DRAWINGS

FIGS. 1-8 show screenshots from an embodiment that includes aspects of the detailed technology.

### What is a Spin?

A Spin is a collection of images or video frames, where each image is associated with the orientation at time of collection. Playback of a Spin differs from playback of conventional video in that the playback is not controlled by or adherent to a time track, but rather the user adjusts a desired orientation by dragging, swiping, or changing orientation of the smartphone or playback device. As the desired orientation changes, the video frame is displayed that was captured at an orientation closest to the desired orientation.

The effect that users experience is a free spin around an object, or in an environment, that is independent from the timing of video or manner in which the video was captured. Unlike stitched panoramic images, a Spin can capture environments that include motion, and can show all sides of an object from the outside rather than just from the inside.

### Collection

In a typical Spin collect, a user starts the Spin app which starts a camera video feed as well as one or more orientation sensors. Orientation sensors may include gyroscope, magnetic compass, and/or accelerometer. By sensing one or more of these sensors or by a fusion of these sensors, an orientation of the phone is determined. The orientation can either be an absolute direction (such as magnetic bearing) or a relative angle that could be acquired from a gyroscope, or a fusion of these measures.

The app captures video frames at a given frame rate (e.g. 30 frames per second). Only a subset of video frames are added to the Spin, such that the Spin represents orientations that are spread out across orientation. Though orientation may generally be multi-axis, in one embodiment only a single axis of orientation is used. For purposes of discussion, this axis of orientation can be called “bearing”. Frames are collected that are spaced sufficiently from frames corresponding to similar bearings. For example, we collect a frame at 0 degrees, 2.1 degrees, 4.3 degrees, etc. An orientation tolerance (e.g. angle tolerance) is used to determine if the orientation associated with a captured frame is sufficiently far from existing frames such that the frame should be added to the Spin.

In one embodiment, as each frame is delivered, a determination is made as to whether or not that frame should be added to the Spin by comparing the angle of orientation at capture to the angle of orientation of every frame already in the Spin. If the difference between the angles is greater than or equal to a prescribed angle tolerance (e.g. 2.0 degrees) then the frame is added to the Spin along with the orientation meta-data; otherwise the video frame is discarded.

In one embodiment, the collection software makes a determination when a Spin has completed 360 degrees of rotation, and automatically ends the collection. User controls allow manual stopping of collection prior to 360 degrees of rotation.

The product of the collection process is a series of images, each with associated orientation meta-data, and potentially additional meta-data of the capture such as GPS location, time and date of capture, etc. The series of images can be encoded as separate compressed images or encoded into a compressed video for transport and/or display.

### Defining Orientation

The orientation that corresponds to frames can be a one, two, or three-dimensional property. In each of these it is essential to be able to compare orientations in order to collect a set of images with orientations that are fairly evenly distributed.

In one embodiment, orientation is three-dimensional, and orientations are differentiated by reducing the difference between the two 3-D orientations to a single scalar value. For example, this could be accomplished by finding the rotation that transforms one orientation to the other, and measuring the degrees of that transforming rotation.

In another embodiment, orientation can be reduced to a two-dimensional property. For example, Yaw and Pitch can be utilized while Roll is discarded. These orientations then can be visualized as on the surface of a sphere. If one imagines three orthogonal axes representing the orientation at the center of a sphere, the point on the sphere can be, for example, where the z-axis intersects the sphere. In order to find the difference between two of these 2-D orientations one could, for example, find the length of arc between two points on the sphere.

In a preferred embodiment, orientation can be reduced to a one-dimensional property. In this embodiment, an orientation is represented as a single angle, which may represent a rotation from an arbitrary standing point or a fixed bearing. Orientation can be reduced in many manners—in one method, only one axis of the smartphone's gyroscope is measured, resulting in an angular measure. For example, on an iPhone held in Portrait mode, the Y-Axis of the gyroscope corresponds to rotation about a vertical axis and if a user is capturing frames while holding the phone in Portrait mode, the Y-Axis rotation describes orientation.

In practical terms, however, users will generally not be holding the phone perfectly vertically, but may angle the phone slightly upwards or downwards while rotating or pivoting about an imaginary vertical pole. In order to properly extract an angle that measures 360 degrees when the circle is complete, the angle of the gyroscope Y-axis can be divided by the accelerometer's Y-axis component to yield an angle offset that does indicate how many degrees they have rotated about an imaginary vertical pole. This measure is but one way to reduce orientation to one dimension.

On devices that do not have a gyroscope, a magnetic compass reading can be used instead, and a measure of magnetic bearing can be used as a scalar value of orientation. Fusion of compass and accelerometer values can also be performed (for example, as described in the incorporated by reference document “Method of Orientation Determination by Sensor Fusion”), resulting in a full three-dimensional orientation that can be reduced in any number of manners, such as those described above.

### Playback

Spins can be played back on a multitude of platforms, including from smartphone apps, in a web browser, or on a conventional (desktop) application. A user selects a Spin to display, and the Spin is initialized with arbitrary orientation angle (e.g. 0 degrees).

The user can then manipulate the desired orientation angle in a number of ways; for example, in one embodiment, by tapping or clicking and then dragging, the angle can be adjusted proportionally to the direction and screen distance travelled during the drag. If the user releases the mouse button (or lifts their finger from a touch screen) then angular velocity is maintained from the release, as would be the case if the user were manipulating a physical wheel, and velocity then decays based on a simulated drag. As the decay advances, the angular velocity is cut off at a minimum angular velocity and set to zero.

After each adjustment to orientation angle, the images of the Spin are searched to determine which frame was captured at a orientation closest to the desired display orientation. The frame is then displayed. This allows the user to scrub around the object or environment by orientation in a way that is independent from the timing or direction that the frames were collected.

### Sharing

Collection generally occurs on the user's smartphone and can be displayed immediately on the same device. In order for others to view the Spin, it must be shared to a central computer server or cloud storage. If a user wishes to share a Spin, the Spin's collection of images and associated meta-data is uploaded to the server across a data network or the Internet.

Upload of images can happen in many ways; for example a zip file can be uploaded that contains the images as well as the meta-data, or the images can be encoded into a compressed video to take advantage of coherence between frames. The images can be individually extracted from the compressed video on the server if needed. As video compression can have significant savings in transfer size, display clients such as smartphones can download the compressed video and then break it up into stored individual frames on the device for random access to frames.

Once uploaded, the Spin data is associated with a user and entered into a back-end database that indexes all shared Spins by user, location, date, and/or subject matter.

### Image Stabilization

As Spins may be collected from a hand-held device, it follows that the user may not perfectly center the subject matter in each frame of the Spin. If this results in a jittery playback there are several available solutions to stabilizing the images. The stabilization step can happen either at time of collection, time of transmission, or time of display.

Image stabilization is well documented at sources such as Wikipedia—http://en.wikipedia.org/wiki/Image_stabilization. Digital image stabilization is a common feature on consumer video cameras. The technique generally works by shifting the electronic image from frame to frame to minimize optical flow. This same technique can be used to minimize the motion in a Spin, with the effect of keeping the subject centered.

One can often safely assume that the person holding the smartphone is holding it at a consistent height. If this is the case, the accelerometer in the device can indicate the angle that the user is holding the device. Knowing this angle, one can shift (and distort) this image to produce an image that would be taken an a consistent angle (for example, the starting angle). By using other devices such as a gyroscope, one can determine more degrees of freedom of the pose, and with positioning systems such as GPS or systems with even higher accuracy, one can determine a full attitude pose which can be used to further correct the image.

Other techniques that can be used to stabilize the image include techniques employed by Microsoft Photosynth. This technology identifies salient points in images and is able to make a correspondence between the points between separate images.

### Web Server

A website allows web users to browse and display Spins in a manner similar to sites such as Flickr and YouTube. The website communicates with a back-end server that stores all shared Spins and associated orientation and session meta-data.

The website allows users to browse Spins by many criteria, for example by popularity, by subject, by date, or by user. Playback can occur directly using web protocols such as HTML or Flash. The Spin can be requested from the server as individual compressed images or as a compressed video for display.

The website also facilitates rating of Spins by user, for example by “Liking” a Spin or by giving a 1-5 star rating. Users can also share Spins on the website via social media such as Facebook, Twitter, etc.

### Tagging

Tagging can be performed either in the smartphone app or through a web browser. On any given frame of the Spin, the user clicks or taps within the image to mark a location. The horizontal component of this location is then converted into an angle where the tag will always be displayed, and the vertical location is used to position the tag vertically in all frames.

The tag is then associated with a person, place, or object, or handles to people, businesses, objects, etc., in social sharing sites such as Facebook.

As every frame is shown upon display, the tag is rendered at a location on the screen that corresponds to the angle at which the tag was placed. This is accomplished by projecting the polar coordinate associated with the tag through the rotation transformation of the desired angle and a projection transformation matching that of the camera used for capture. The result is a tag that moves across the Spin while the user drags, always attached to the object that was tagged as it moves across the screen.

Tag data is uploaded to the web server to be shared with other users, and is downloaded into mobile or web viewers along with other Spin meta-data.

### Social Networking Integration

Spins can be shared via social media either directly from a mobile app or via the website. For instance, Facebook integration allows users to post a link to the Spin on Facebook where it can be viewed by friends. Although the Spin cannot presently be played in Facebook, a single frame from the Spin is included in the Facebook post. Additionally, a link to a URL on the Spin website directs the user to a web page (outside Facebook) that displays the Spin.

A similar sharing mechanism can happen with Twitter, in which the link to the Spin website corresponding to the shared Spin is included in the tweet. Optionally, a link to an image representing a frame from the Spin can be included in the tweet (some Twitter browsers will display the image associated with that URL).

“Liking” a Spin can be accomplished in many ways. First, a user can simply like the post that shares the link. The Spin website also includes a Like mechanism that allows Spins to be rated by popularity, or can be used to show which users like which Spins. This Like mechanism can be independent from that of any social media site, but ideally is also tied to the Like mechanisms in other sites, so that social network users can see who likes what Spins from within the social networking sites.

The description of sharing mechanisms is not limited to those systems described, and the reader can reasonably infer that Spins can be shared in a similar manner on any social sharing site.

### Screenshots

The screenshots of the SpinCam app discussed below aid in demonstration of one embodiment of the technology.

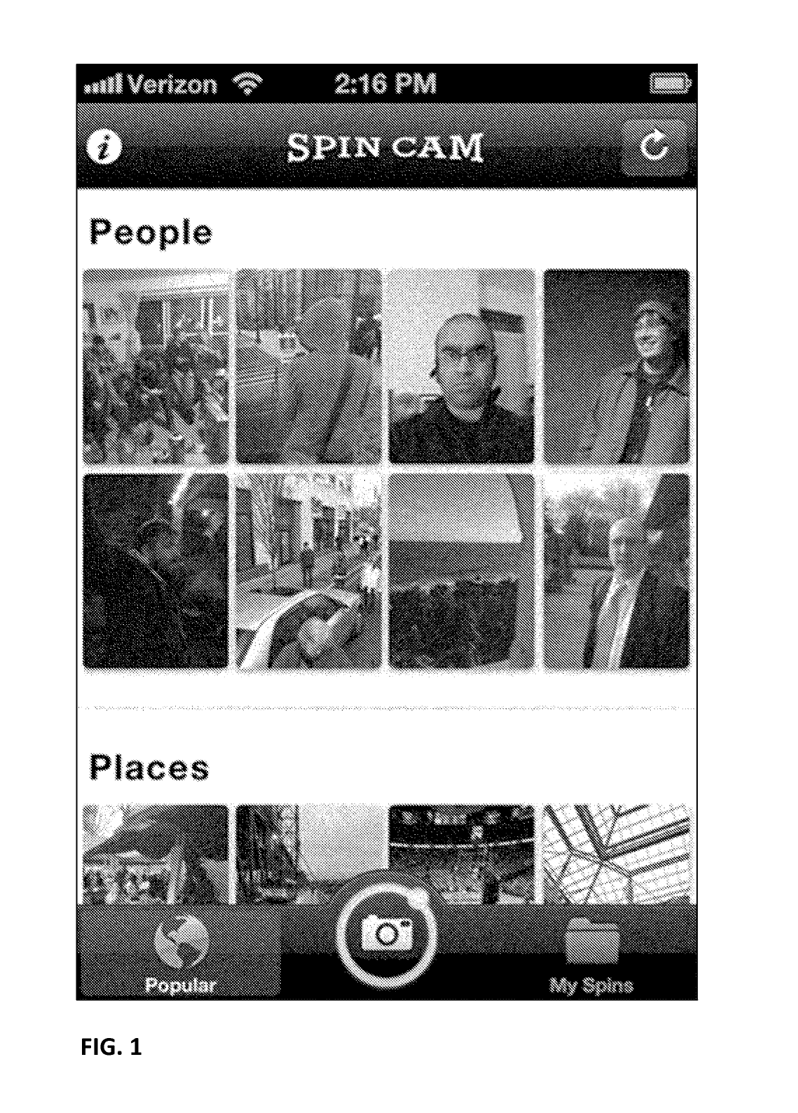

As shown in FIG. 1, the SpinCam app starts on the Popular tab, which displays a feed of popular Spins. This page may be a news feed or a personal feed based on the users preference of liked or followed Spins or Users. The button at the top right allows the user to refresh the display with more up-to-date content. Two additional tabs at the bottom of the screen allow the user to capture a new Spin, and to see the list of Spins collected by this user.

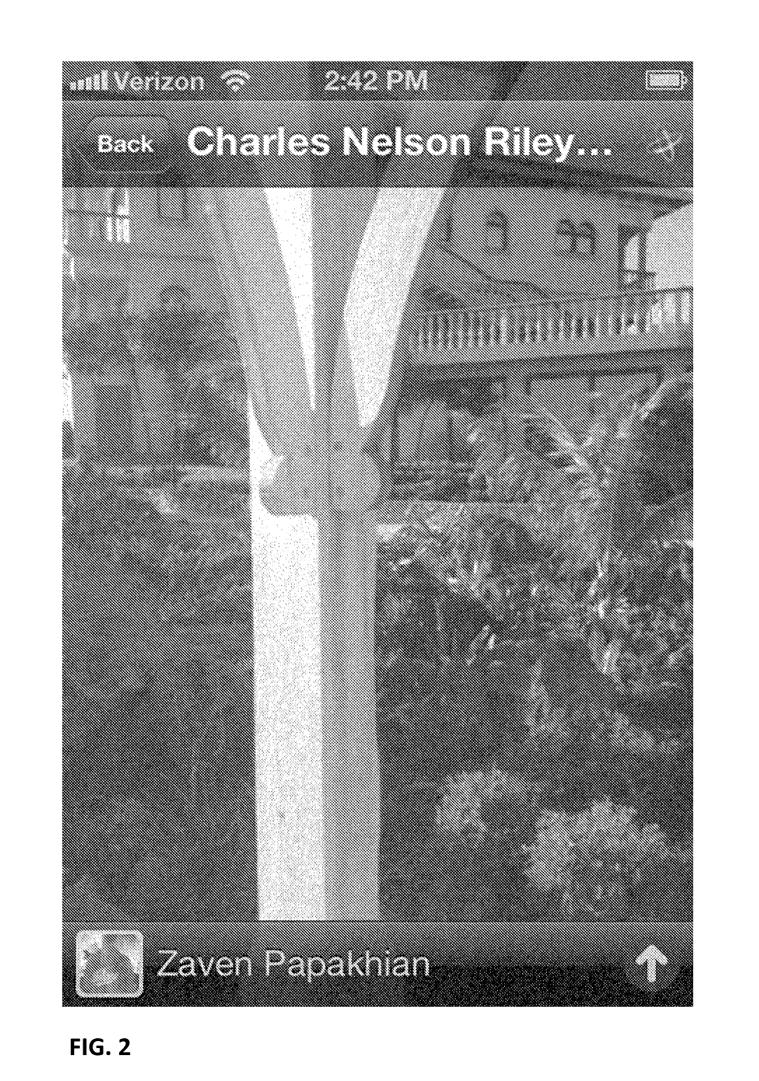

As shown in FIG. 2, after tapping on the image of a Spin we are taken to the Spin playback screen. The title of the Spin is listed at the top of the screen, and user information is listed at the bottom. The gyroscope icon at the top right can be activated to allow the user to manipulate the Spin by rotating the device. In common usage, the person holds the phone out and rotates their body, which causes the imaginary wheel to spin and imagery is displayed based on the users current orientation. A user may also swipe the screen with their finger at any time in order to change the viewing orientation and corresponding images. The panel at the bottom of the screen can be tapped to bring up more information and options.

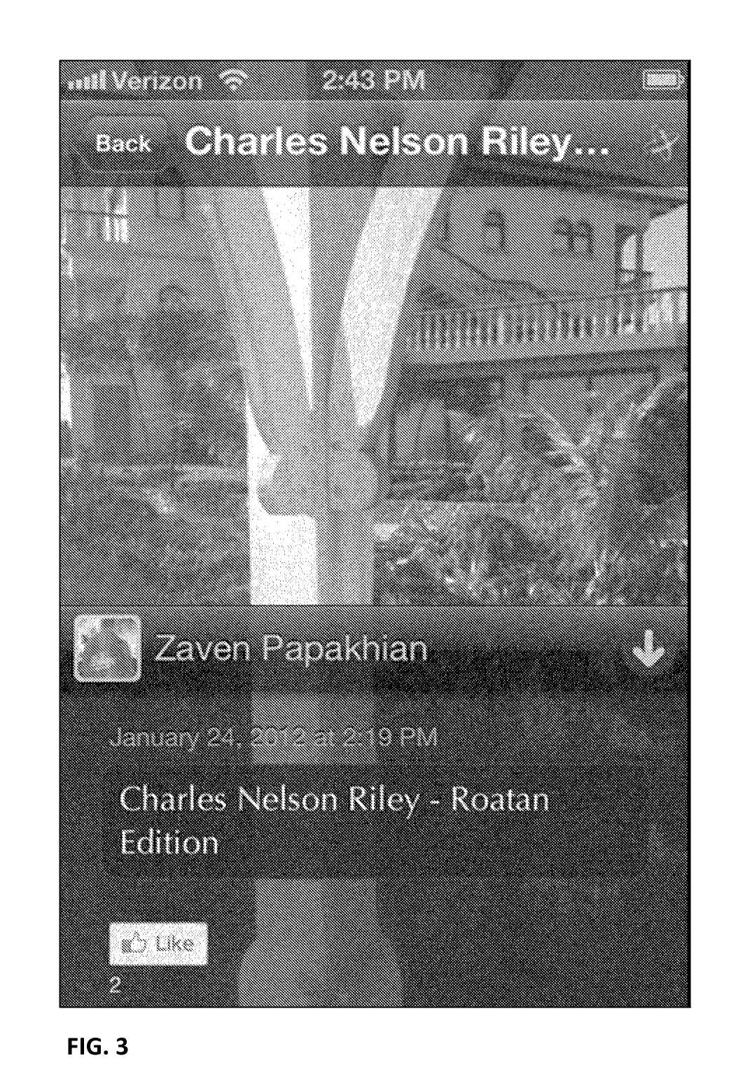

FIG. 3 shows the Spin Playback Screen with information panel raised. (This is accomplished by tapping on the panel or the arrow from the previous screenshot). Additional information include the full title and time the Spin was shot. Other information that could be included here includes the location the Spin was shot, who likes the Spin, and additional information on the user that shot the Spin. Below the title is listed a Facebook like button and a count of how many people have liked this Spin.

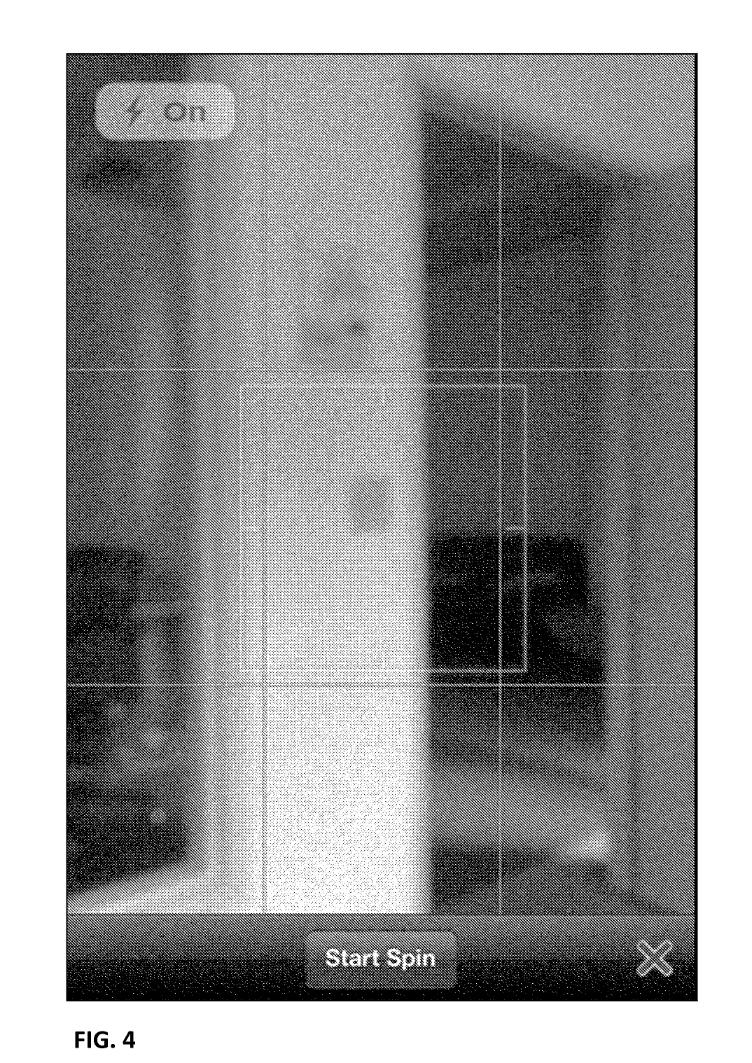

The Spin capture screen initially shows a camera view, as shown in FIG. 4. Users can turn on controls like the torch and can adjust focus by tapping on the screen. Auto-focus is also active and will focus when the image appears out of focus. When the user presses the Start Spin button the capture of images is initiated and focus is locked.

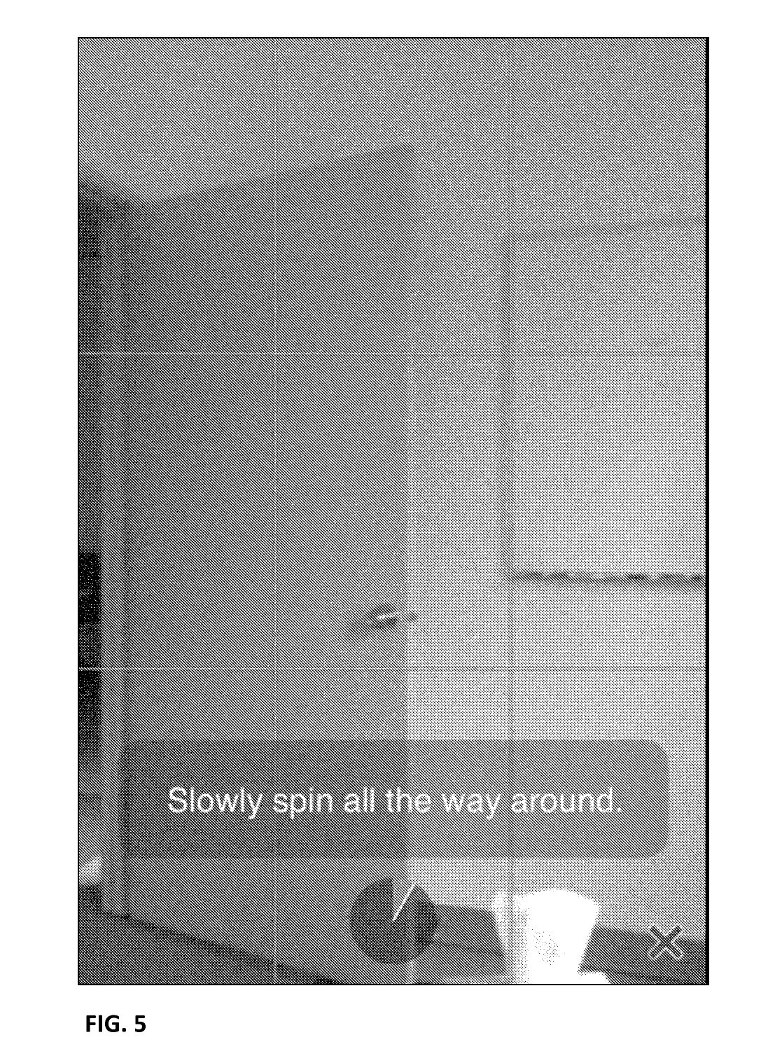

After pressing the Start button on the Spin Capture screen, the user is instructed to spin all the way around. A pie chart indicates their current orientation and how far they need to go to complete the Spin, as shown in FIG. 5. The Spin stops automatically when SpinCam senses they have made a complete revolution. The user can cancel the Spin at any time by pressing the “X” button.

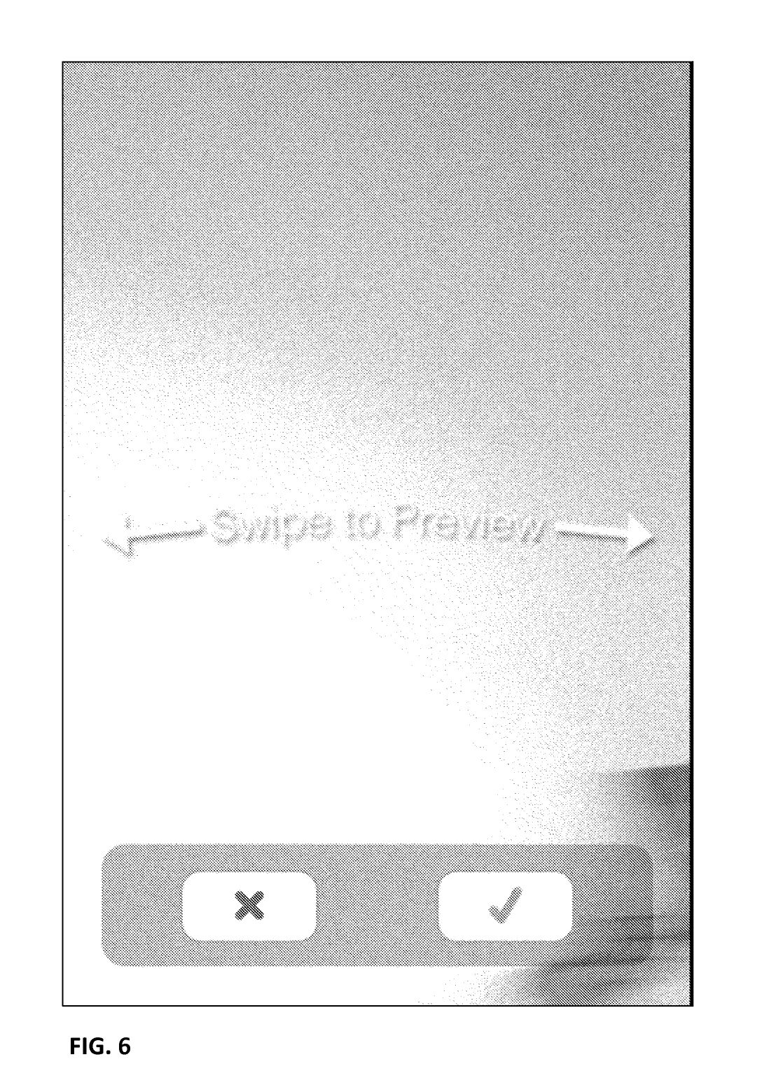

After completing the rotation, SpinCam senses the Spin is complete and presents a Preview screen (FIG. 6). The user is prompted to swipe to preview, and if satisfied with the Spin they press the check button to proceed to title and share the Spin. If not satisfied, the user presses the “X” button and is returned to capture another Spin.

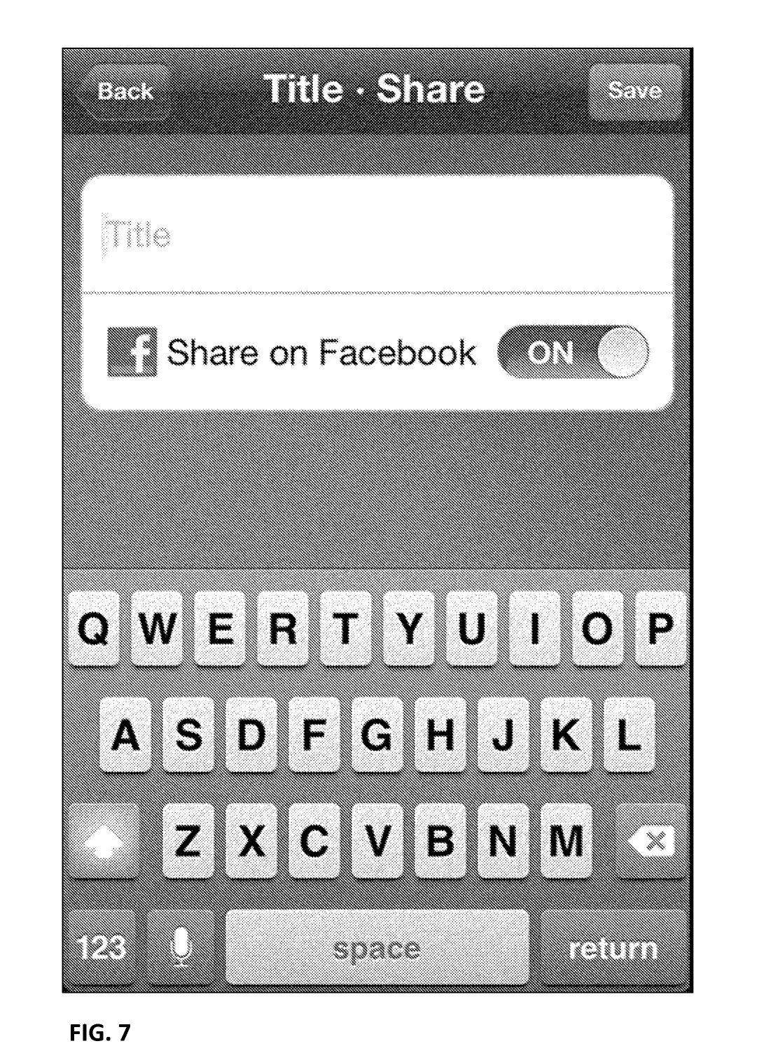

After approving a Spin, the user is prompted (FIG. 7) to add a title to the Spin, and if Share on Facebook is on, the Spin will be shared. Sharing a Spin may require Facebook authentication and if this is the case, the user is navigated into the Facebook app or webpage and then returned to the SpinCam app. The user is shown a Facebook thumbs up to indicate they have shared the Spin and then they are free to close the app or continue capturing or browsing Spins. If a Spin is to be shared on Facebook, the Spin is uploaded in a background process and shared once the upload is complete.

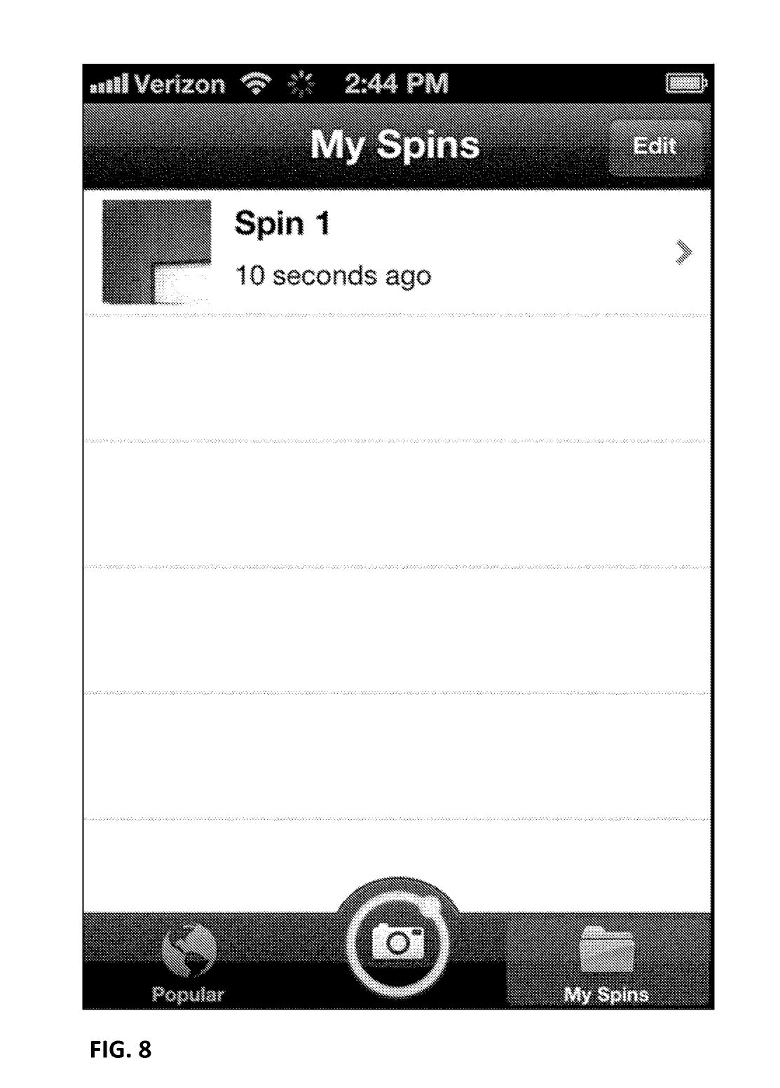

The My Spins tab (FIG. 8) shows the Spins that the user has personally collected. Each Spin is shown with a thumbnail preview image as well as the date when it was captured. Pressing on a Spin will take the user to the Spin playback screen with the chosen Spin loaded.

### Example Uses

The following are just a small sample of the many uses for disclosed technology:

### Capturing a 3D Object

A museum goer wants to capture the experience of seeing a three-dimensional sculpture. She takes the smartphone from her pocket and opens the SpinCam app. Then while standing a few feet from the sculpture she aims the smartphone at the sculpture and initiates the capture. The app automatically captures her first frame, and then she begins to walk in a circle around the sculpture while aiming at the center. Sensing the change in orientation, the app then captures frames whenever her orientation is a couple degrees from the last captured image. When she has circled the sculpture completely, the app senses that and vibrates to inform her that her Spin has been completely captured. She then reviews the Spin by flicking her finger across the screen while the simulated orientation rotates and corresponding frames are played back. Upon acceptance of the Spin she adds a title and decides to share the Spin on Facebook. Her friends see the Facebook post of the title and an image from the Spin and when they click on the image they are able to interact with the Spin in their web browser (or in their SpinCam app if browsing on a mobile phone).

### Capturing a Panoramic View of a Place

A tourist wants to capture a scene on a Paris street. He opens the SpinCam app and initiates a capture. He the holds the phone at arm's length while turning 360 degrees. Images are captured during his rotation and corresponding orientations are recorded as meta-data with the captured images. Notably, as images are captured at different points in time, the images will describe motion of the street scene—the walking of passers by, the street juggler, the fluttering of tree leaves in the wind. He then shares the Spin with his friends who can experience the immerse experience remotely (for example, via posting to a social sharing site, by emailing, or sending a link to the Spin through an SMS message).

### Capturing a Social Scene

A teenager takes his smartphone to a party and slyly captures a Spin of his friends. The app then allows him to tag his friends by swiping through the playback—as each friend becomes visible, he taps the screen which indicates both the height of the tag in the image and its associated orientation (by determining the orientation represented the ray in the view frustum of the camera projection at the camera's current pose). He then posts the Spin to his favorite up and coming social network. As his friends have been tagged, they are notified that they appear in the Spin, and they then view the Spin. As his friends view the Spin, tags are rendered as augmentation in a two- or three-dimensional space that projects to the viewer's screen and are superimposed on top of the captured frames. By tapping a tag, the viewer can then follow a hyperlink to a the tagged person's social network page, or to a webpage indicated by a URL associated with the tag.

To provide a comprehensive disclosure without unduly lengthening this specification, the documents and reference works identified above and below are incorporated herein by reference, in their entireties, as if fully set forth herein. These other materials detail methods and arrangements in which the presently-disclosed technology can be incorporated, and vice-versa.

1. A method of capturing images that are each associated with orientation, and playing back the images under the control of a user who is turning an imaginary rotational control.

2. A method comprising:
capturing first imagery from a subject using a camera-equipped phone, when the phone is oriented at a first angle, providing an image of the subject taken from a first direction, and adding said first imagery to a spin data structure;
by reference to a position sensor in the phone, sensing movement of the phone orientation to a second angle at least N degrees from the first angle, and adding second imagery captured of the subject at said second angle to said spin data structure, providing an image of the subject taken from a second direction;
by reference to a position sensor in the phone, sensing movement of the phone orientation to a third angle at least N degrees from the second angle, and adding third imagery captured of the subject at said third angle to said spin data structure, providing an image of the subject taken from a third direction;
by reference to a position sensor in the phone, sensing movement of the phone orientation to a fourth angle at least N degrees from the third angle, and adding fourth imagery captured of the subject at said fourth angle to said spin data structure, providing an image of the subject taken from a fourth direction;
wherein a sequence of images is collected at different phone orientation angles, which images can be rendered in a temporal sequence to create an illusion of spinning around the subject to show views thereof from multiple directions.

3. A method comprising:
capturing first imagery from a subject using a camera-equipped phone, when the phone is oriented at a first angle, yielding an image of the subject taken from a first direction, and adding said image to a spin data structure
capturing a timed sequence of further imagery using the camera-equipped phone, yielding a sequence of plural candidate images; and
processing the sequence of plural candidate images, and adding only selected ones thereof to the spin data structure;
wherein the method includes selecting images for addition to the spin data structure by judging a bearing of a candidate image against a bearing of an image earlier added to the spin data structure, and adding said candidate image to the spin data structure only if its bearing exceeds that of the image earlier added to the spin data structure by at least a predefined threshold amount.

4. The method of claim 3 that further includes adding, to the spin data structure, bearing data corresponding to each of the candidate images added to the data structure.

5. A method comprising:
presenting a first image on a touchscreen of a portable device;
in response to a user swipe gesture on the touchscreen, replacing the first image with a second image, without any transitioning effect, and similarly replacing the second image with a third image, again without any transitioning effect;
the first, second and third images having been earlier captured by a single camera that was moved to point successively in first, second and third viewing directions;
wherein a stop action sequence of images is presented, through which the user can navigate to a desired viewing direction by swiping the touchscreen.

6. The method of claim 5 wherein the first, second and third images depict a subject that was in motion when said images were earlier captured by the camera, and wherein the camera itself was moving during capture of said images.

7. The method of claim 5 in which the first, second and third images were earlier captured by a single camera that moved in a curved arc, pointing to a subject inside the curve of the arc.
